(19) United States
(12) Patent Application Publication
(10) Pub. No.: US 2006/0290322 A1
(43) Pub. Date: Dec. 28, 2006

(54) Charge indicator for an energy source

(75) Inventor: Joseph A. Carbonaro, Wheaton, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/168,134

(22) Filed: Jun. 27, 2005

(51) Int. Cl. H02J 7/00

(52) U.S. Cl. 320/132

(57) ABSTRACT

A battery charge indicator for a mobile communication device, such as a cell phone. The battery charge indicator receives an indication of battery power, uses the indication to determine an estimated service life of the present charge of the battery during an idle mode of the mobile communication device, uses the indication of battery power to determine an estimated service life of the present charge of the battery during an active mode of the mobile communication device and control a display element to provide visual indications in a time domain of the estimated service life of the battery charge for the idle and active modes of the mobile communication device.

### FIELD OF THE INVENTION

This invention relates to an apparatus comprising and a method of operating a charge indicator for an energy source of a mobile communication device. The invention further relates to a charge indicator adapted for use in a battery-operated mobile communication device, such as a cell phone. This invention still further relates to a mobile communication device having a charge indicator adapted to provide a visual display of the estimated service life of the present charge of a battery in the time domain.

### PROBLEM

Portable battery powered electronic devices are in widespread use in mobile communication devices, such as mobile phones and cell phones. These mobile devices function satisfactorily as long as their batteries have a sufficient charge to supply power to the devices.

It is known to equip mobile communication devices with bar indicators representing an approximation of the present status of the battery. Currently available battery charge indicators are inadequate in that the information they provide does not accurately indicate the estimated service life of a battery charge. They also do not indicate whether the battery is old or new. They also do not indicate power characteristics of the battery in terms of the remaining service life of the battery charge or the power delivery capability of the battery. A premium battery typically has a longer service life and a greater power delivery capacity than a less expensive battery. Both batteries have the same output voltage when first installed. The information provided by a charge indicator having one or more bars does not differentiate between battery types. Batteries may be rated for 6, 12, or 24-hours of talk time. An indicator having a single bar may represent one quarter, one third, or one half of the resident battery charge. This information is of little value to a user who may not remember the battery rating. Also, the information displayed by the bar indicator is the best an approximation and does not have the precision required to assist a user in many situations. A user may be required to determine whether a battery has a sufficient charge to power a cell phone for the time required on a conference call or for the time required to download a large data file. Information regarding the battery charge is also useful so that a cell phone does not lose power midway through a conference call or midway through the downloading of a large data file.

A large data file may require 12 minutes to download. In such cases, the user needs to know whether the battery charge is sufficient to power the mobile phone for the estimated download time. A user also needs to know the remaining service life of the battery charge for a voice call. If the communication device has a single indicator bar, the user does not know whether the bar indicates 10 minutes of talk time or 10 seconds. In an idle/power up mode, the user often must make a decision whether to make a call depending upon the remaining service lifetime of the battery charge. The user needs to know the available talk time so that important calls are not dropped.

In summary, the currently available battery charge indicators of the bar type are less than ideal since they do not provide accurate information regarding the present charge of the battery.

### SOLUTION

The present invention solves the above-discussed problems by the provision of an apparatus for and a method of operating a charge indicator of a mobile communication device having an energy source, such as a battery. The mobile communication device of the present invention has an active mode that includes a talk mode and a data mode.

The charge indicator is adapted to receive information specifying the magnitude of the present charge of the energy source. The charge indicator uses the information specifying the magnitude of the charge to determine an estimated service life of the charge for an idle mode of the mobile communication device. The charge indicator also uses the information specifying the magnitude of the charge of the energy source to determine an estimated service life of the charge for an active mode of the mobile communication device. The charge indicator is responsive to the determinations of charge magnitude to operate a display element to provide visual indications in a time domain format of the estimated service life of the charge for the idle mode as well as for the active mode of the mobile communication device. The provided indication may be visual, audible or both. A display in a time domain format of hours and/or minutes and seconds provides precise information to a user specifying the estimated remaining service life of a charge of a battery. Information in this format is advantageous in that it informs the user of the exact amount of time remaining for use on a call or for use in downloading a large data file. This provides protection to the user against the interruption of a call or an aborted downloading of a data file due to a decay of the present charge of the battery.

The charge indicator receives information identifying one or more characteristics of the battery for use in the determinations of the estimated service life of the present charge of the battery. One of the received characteristics may specify the magnitude of the rated charge of the battery. Other information may represent the battery type and the magnitude of the present charge of the battery. Other possible received information may be the in-service hours of the battery. One or more of the above characteristics may be used in the determination of the estimated service life of the present charge of the battery. This information may also be used to create a discharge curve that compensates for the in-service time of the battery. The discharge curve may also be used in the determination of the estimated service life of the charge of the battery.

The estimated service life of the charge for the idle mode may be multiplied by a percentage factor to determine the estimated service life of a charge for the active mode. The estimated service life of the charge for the active mode may be based upon the signal strength transmitted by the mobile communication device during the active mode. The estimated service life of the charge for the active mode may alternatively be determined by the reception of a control signal from the communication network serving the mobile communication device. The control signal may specify the transmitted signal power to be used by the mobile communication device during the active mode. The estimated service life of the charge for the active mode may alternatively be determined by sampling the power usage of the mobile communication device during the active mode. In response to the above determinations, the charge indicator operates a display element to provide visual indications in a time domain of the estimated service life of the present charge of the battery for the idle mode as well as for the active mode of the mobile communication device.

The charge indicator may be operated to receive information indicating the size of a file to be downloaded, to determine the estimated service life of the present charge of the battery and, in response to this determination, to determine whether the charge is sufficient to operate the mobile communication device for the time required to download the file. The charge indicator then operates a display element to provide a display of whether the present charge is sufficient to accommodate the downloading of the file. The display provided by the charge indicator in the time domain may specify time in a format comprising hours, minutes and seconds.

### DRAWINGS

The foregoing and other objects and features of the invention may be better understood from a reading of the following detailed description thereof taken in conjunction with the drawings in which:

FIG. 1 discloses one possible embodiment of the invention;

FIG. 2 is a flow chart disclosing steps embodying the invention;

FIGS. 3,4 and 5 illustrate typical displays generated by an apparatus embodying the present invention; and

FIG. 6 illustrates typical discharge curves of a battery.

### DETAILED DESCRIPTION

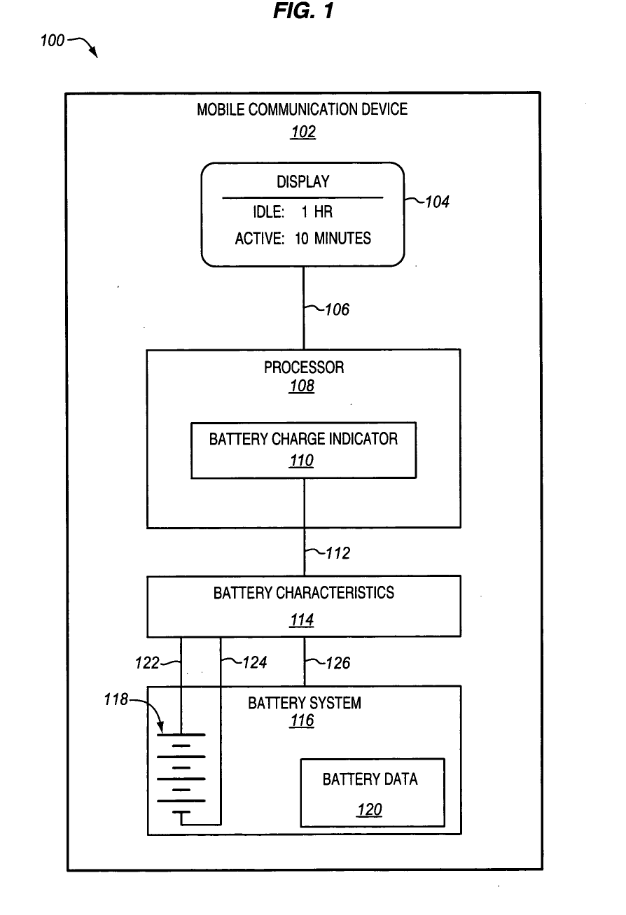

FIGS. 1-6 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

Description of FIG. 1

FIG. 1 discloses a mobile communication device 102 having a battery charge indicator 100. Mobile communication device 102 includes a display 104 and a processor 108. Processor 108 has battery charge indicator 110. Display 104 is connected by path 106 to processor 108. Battery charge indicator 110 is connected by path 112 to battery characteristics element 114. FIG. 1 also discloses a battery system 116 having a battery 118 and a battery data element 120. Paths 122 and 124 connect battery 118 to battery characteristics element 114. Path 126 connects battery data element 120 to battery characteristics 114.

The above-identified apparatus receives information pertaining to the present condition of battery 118. This information is transmitted to battery charge indicator 110 which is controlled by processor 108. Processor 108 processes the received battery information and generates an estimate of the service life of the present charge of battery 118. The generated information regarding the estimated service life of the present battery charge is in a time domain format of hours, minutes and seconds. This estimated service life information in the time domain format is transmitted from processor 108 over path 106 to display 104. Display 104 receives the information in the time domain format and provides a visual indication in hours, minutes, and seconds of indicating the estimated service life of the present charge of battery 118. If desired, the display may be visual, audible or both visual and audio audible.

This mode of operating processor 108 in generating the above-described information in the time domain is to be distinguished from the operation of a prior communication device that does not embody the present invention. A prior communication device not embodying the present invention merely samples battery information to generate a signal that controls the width of a bar indicator. As elsewhere described herein, the information provided by a bar indicator is merely an approximation of a battery charge that does not provide the precision information required by a user to make an intelligent decision regarding the capabilities of his/her mobile communication device to provide required call service. This is to be contrasted with the signals generated by processor 108 of the present invention which are in a time domain format that operates a display element to provide precise information to a user regarding the capabilities of a present battery charge to provide required calls service.

FIG. 1 illustrates display 104 when providing an estimate of the service life of the battery charge upon the startup of mobile communication device 102. Display 104 indicates that the estimated service life of the present battery charge is one-hour for an idle mode of the mobile communication device 102 and 10 minutes for an active mode of mobile communication device 102.

Battery charge indicator 110 may embody that portion of a mobile communication device that generates signals that control the existing bar indicator, or the like, of the mobile communication device. As is known to those skilled in art, a typical mobile communication device may have an indicator whose bar width is controlled by circuitry that receives information regarding the present charge of a battery. This information is processed to control the width of the indicator bar. The information provided by the width of the indicator bar is at best an approximation since, as elsewhere described herein, the user cannot use the displayed bar width to determine in terms of hours, minutes, or seconds of the current capability of the battery charge to operate a mobile communication device. In accordance with the present invention, battery charge indicator 110 receives the signal information that has heretofore been provided to the bar indicator and processes the signal information together with other information regarding the estimated service life of the present charge of battery 118 to generate information pertaining to battery 118. This generated information is applied to display 104, which provides a digital display of this information in a time domain. The display of information may include the estimated service life of the present charge of battery 118.

FIG. 1 only discloses the elements of mobile communication device 102 that are relevant to the present invention. It is the understood that mobile communication device 102 will have other elements such as a keypad, function keys, and the other elements required to operate mobile communication device 102. Mobile communication device 102 may comprise any apparatus, such as a cell phone or the like that can initiate or receive calls from other calling devices of any type including the landline or wireless type.

Display 104 may be used by mobile communication device 102 during its normal call serving functions. Processor 108 may include elements and memories (not shown) used in the performance of the call serving functions of mobile communication device 102. Battery charge indicator 110 may be part of the memory of processor 108, which, under control of processor 108, processes the battery characteristics information received on path 112. The processed battery characteristics are transmitted from processor 108 over path 106 to display 104. Display element 104 receives the processed information and provides a visual display in a time domain of information indicating the estimated service life of the present charge of battery 118. This information includes the estimated service life of the present charge of battery 118 as well as other information provided by the battery characteristics element as elsewhere described herein.

Conductors 122 and 124 supply the battery power required to operate mobile communication device 102 in the performance of its call serving functions as well as in the performance of its function of determining and displaying the estimated service life of the present charge of battery 118. Conductors 122 and 124 extend battery voltage 118 to battery characteristics element 114. This battery voltage is further extended via path 112 to battery charge indicator. Battery data element 120 receives and stores various items of information regarding battery 118. This information may include the battery type, the service life of the active and idle modes of battery such as 6,12 or 24 hours. This information may further include the charge capacity of the battery, the date of its installation in mobile communication device 102, the manufacturer's rated life of the battery, the cumulative in-service time of the battery, as well as any other battery characteristics relevant to the operation of mobile communication device 102.

The above information may be entered into battery characteristics element 114 either manually by the user of mobile communication device 102, or may be entered by the battery manufacturer into battery data element 120. Battery data element 120 may be embodied in a “smart chip” affixed to or integrated into battery 118. In such cases, the information stored in battery data element 120 may be partially supplied by the battery manufacture with the remainder of the information being entered into battery data element 120 by the user of mobile communication device 102.

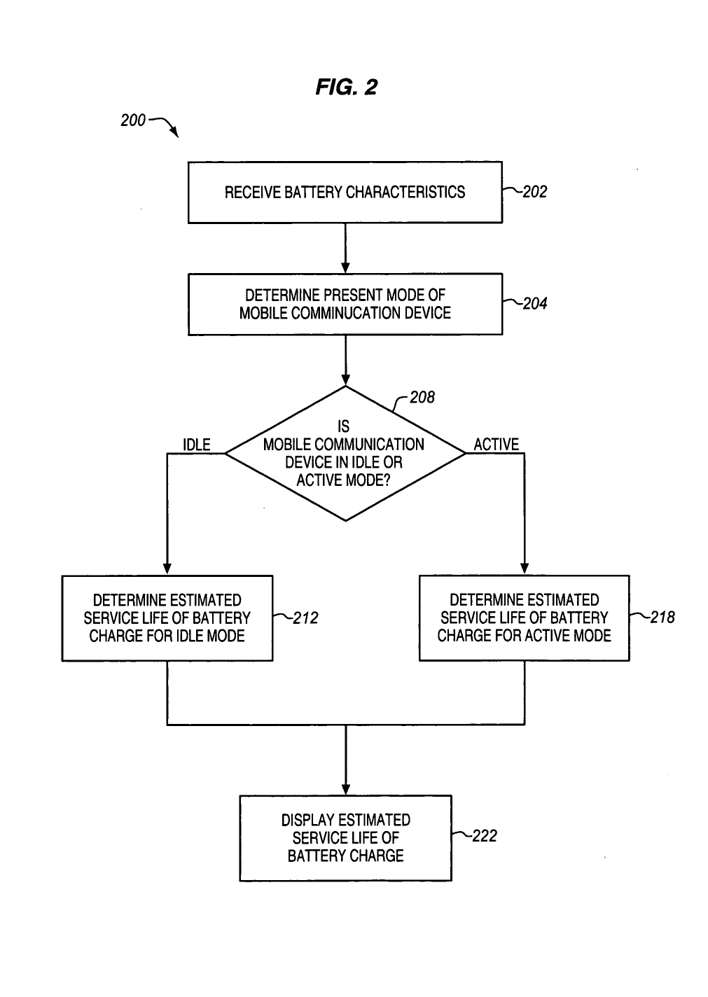

The function of battery characteristics element 114 is to receive the above-discussed characteristics from battery system 116 and to extend the received characteristics over path 112 to battery charge indicator 110. Battery charge indicator 110 and processor 108 process the received information to determine the estimated service life of the present charge of battery 118. Battery charge indicator 110 may also use the received information including the battery characteristics, to operate display element 104 to display relevant battery information useful in the operation of mobile communication device 102. The operation of battery charge indicator 110 is described in further detail in connection with the flowchart of FIG. 2.

Processor 108 and battery charge indicator 110 may provide information indicating whether the estimated service life of a charge is sufficient to permit the downloading of a large data file. This is done by receiving information indicating the size of a data file to be downloaded, determining the estimated service life of the present charge of the battery, generating information indicating whether the estimated service life of the present charge is sufficient to operate the mobile communication device for the time required to download the data file, and generating a display indicating whether the present charge is sufficient to download the data file. A determination of whether to proceed with the download may be made by the user after viewing the display on indicator 110 or, alternatively, may be determined by processor 108 and battery charge indicator 110 of mobile communication device 102.

Description of FIG. 2

FIG. 2 is a flowchart 200 illustrating the steps employed by mobile communication device 102 in the performance of its call serving functions. These call serving functions include a determination of the estimated service life of the present charge of battery 118. The steps of FIG. 2 provide for the operation of mobile communication device 102 by a method in which mobile communication device 102 may be in an idle mode or in an active mode. If mobile communication device 102 is in and idle mode, the estimated service life of the battery charge for the idle mode is determined. If mobile communication device 102 is in an active mode, the estimated service life of the battery charge for the active mode is determined. A display element provides a display of the estimated service life of the battery charge for the present operational mode (idle or active) of communication device 102. The display may be decremented as the battery charge decays with time. The display may provide simultaneous indications for both the idle mode and the active mode. Alternatively, the display may be operated to display the estimated service life of a charge of a battery for only one mode of a time. Alternatively, the display may be operated in a blinking mode to alternately display estimated service life of the charge of a battery for each mode sequentially, one mode at a time.

On FIG. 2, step 202 receives the battery characteristics from element 114 of FIG. 1. Step 204 determines the present operational mode of mobile communication device 102. These battery characteristics may include the present voltage of battery 118 in accordance with a first embodiment of the invention. Alternatively, for other possible embodiments of the invention, these battery characteristics may further include the battery type, the manufacturer's rating of the estimated service life of the battery, the date the battery was installed in mobile communication device 102, the cumulative in-service time of battery 118, and the manufacturer's rated maximum charge of battery 118. These battery characteristics may comprise any one or more of the above characteristics.

Step 208 determines whether the mobile communication device 102 is in an idle or active mode. If step 208 specifies an idle mode, step 212 determines the estimated service life of the battery charge for the idle mode. If step 208 specifies an active mode, step 218 determines the estimated service life of the battery charge for the active mode. Step 222 displays the determined estimated service life of the present battery charge for an idle mode if element 208 determines that mobile communication device 102 is currently in the idle mode. Step 222 displays in a time domain the determined estimated service life of the present battery charge for an active mode if element 208 determines that mobile communication device 102 is currently in an idle mode.

The estimated service life of the charge for the active mode may be determined by multiplying the estimated service life of a battery charge for the idle mode by a percentage factor. Alternatively, the estimated service life of a charge for the active mode may be determined by sampling the consumed power for the mobile communication device during its active mode. Alternatively, the estimated service life of a charge for the active mode may be determined by sampling the transmitted power for the active mode.

The steps of FIG. 2 may generate information indicating whether the estimated service life of a battery charge is sufficient to permit the downloading of a data file in the active mode. This is done by the steps of receiving information indicating the size of a file to be downloaded, determining the estimated service life of the present charge of the battery, generating information indicating whether the estimated service life of the present charge is sufficient to operate the mobile communication device for the time required to download the data file, and generating a display in the time domain indicating or whether the present charge is sufficient to accommodate the downloading of the data file. A determination of whether to proceed with the download may be made by the user after viewing the display on indicator 110 or, alternatively, may be determined by processor 108 and battery charge indicator 110 of mobile communication device 102.

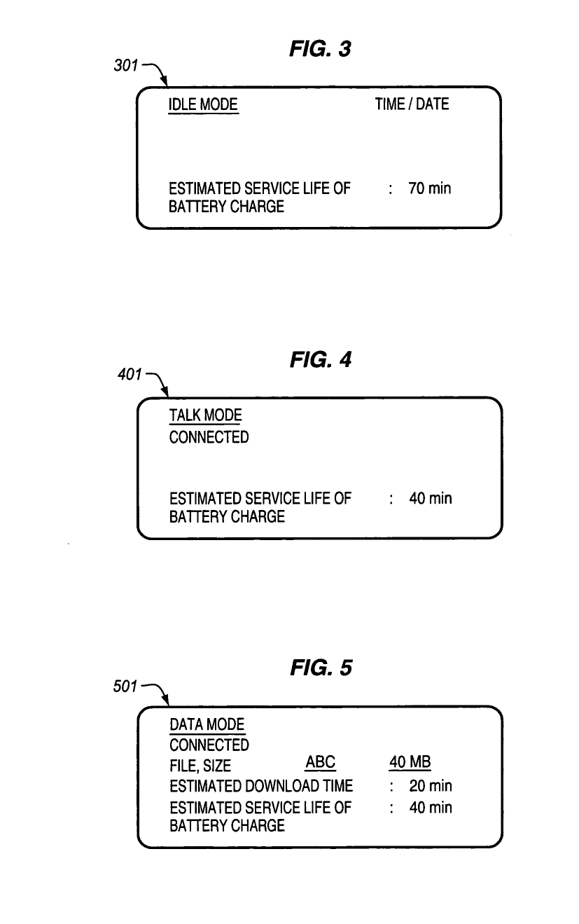

Description of FIG. 3

FIG. 3 illustrates a display screen 301 of the idle mode of communication device 102. The left portion of the top line of the display specifies the idle mode while the right portion of the line specifies time/date information. The bottom line of the display indicates that the estimated service life of the present charge of battery 118 for the present idle mode is 70 minutes.

Description of FIG. 4

FIG. 4 illustrates a display screen 401 representing the talk mode of mobile communication device 102. The top line of the display indicates the talk mode. The next line indicates that mobile communication device 102 is connected on a call. The third line indicates that the estimated service life of the present charge of battery 118 is 40 minutes.

Description of FIG. 5

FIG. 5 shows a display 501 representing the data mode of mobile communication device 102. The top line specifies that mobile communication device 102 is in the data mode. The second line indicates that mobile communication device 102 is connected on a call. The third line indicates the file name and size. The next line indicates an estimated download time of 20 minutes. The bottom line indicates the estimated service life of the present battery charge to be 40 minutes. If desired, the display of FIG. 5 may be provided by a laptop connected to the cell phone rather than by the cell phone. If desired, the cell phone may provide the display as shown in FIG. 5 or, alternatively under user control, may provide the time information of FIG. 5 in the typical cell phone bar format.

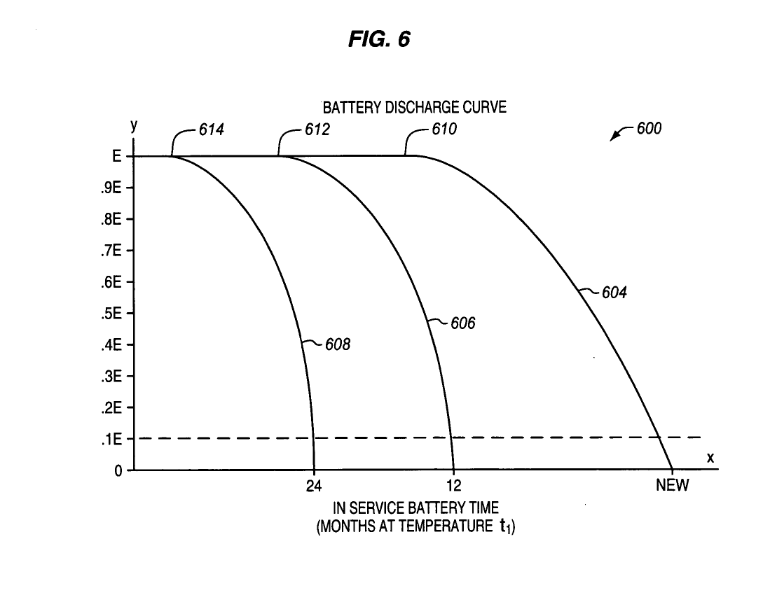

Description of FIG. 6

FIG. 6 is a graph representing typical discharge curves for a battery operating at temperature t₁. The bottom line is the x-axis, which represents the in-service battery time in months. Points are shown along the x-axis for a 24-month battery, a 12-month battery, and a new battery. The 24-month battery is represented by curves 608, the 12-month battery is represented by curve 606 and a new battery is represented by curve 604. Curve 604 representing the new battery intersects the x-axis at the location designated NEW. The vertical Y-axis represents battery voltages. These voltages range from zero at the intersection with x-axis to a value of E representing a maximum value of the battery voltage when new. Those skilled in the art will appreciate that a battery has a maximum voltage when new and that the battery voltage decays as it ages and also decays when power is delivered by the battery to a load.

Graph 604 representing a new battery maintains its rated voltage of E for a longer period of time before decaying than does an older battery. Curve 608 represents the decay of a battery that has been in-service for 24 months. This battery has an output voltage of E when not supplying power. But its output voltage starts to decay at location 614 when supplying current. Curve 606 represents the discharge curve for a battery that has been in-service for 12 months of its rated 24-month life. As shown by graphs 606, this battery has a no-load voltage of E. The no-load voltage is maintained until transition 612 is reached at which time the output voltage decays to a 0.1E voltage, which represents the end of the useful life of the battery.

It will be recognized by those skilled in the battery art that the power delivery capabilities of a battery are temperature dependent. It is common knowledge that a battery may function satisfactorily at moderate temperatures but will become unsatisfactory, or even useless, in delivering power if its temperature decays to subzero temperatures. A battery may be capable of delivering adequate power at 70° F. but may become useless at (−50° F.)

In summary, FIG. 6 illustrates that a new battery may deliver power at its rated voltage E for a longer period of time than a battery that has been in-service for half of its rated life or for the entirety of its rated life. FIG. 6 also indicates that a battery will deliver power at its rated voltage for a length of time depended upon the in-service life of the battery.

I claim:

1. A charge indicator for an energy source of a mobile communication device comprising:
apparatus adapted to receive an indication of the magnitude of the present charge of said energy source;
apparatus that uses said indication of said charge magnitude to determine an estimated service life of said present charge for an idle mode of said mobile communication device;
apparatus that uses said indication of said charge magnitude to determine an estimated service life of said present charge for an active mode of said mobile communication device;
apparatus responsive to a determination of an idle mode to provide a visual indication in a time domain of said estimated service life of said present charge of said energy source for said idle mode of said mobile communication device; and
apparatus responsive to a determination of an active mode to provide a visual indication in a time domain of said estimated service life of said present charge of said energy source for said active mode of said mobile communication device.

2. The charge indicator of claim 1 wherein said energy source defines a battery, said charge indicator further comprising:
apparatus for receiving information defining at least one characteristic of said battery for use in said determinations of said estimated service life of the present charge of said battery.

3. The charge indicator of claim 2 wherein said at least one received characteristic specifies the magnitude of the present charge capacity of said battery and/or the in-service hours of said battery.

4. The charge indicator of claim 2 further comprising:
apparatus adapted to receive information indicating the size of a file to be downloaded;
apparatus adapted to determine the estimated service life of the present charge of said battery;
apparatus responsive to said determination of said file size as well as said estimated service life of said present charge of said battery to generate information indicating whether said charge is sufficient to operate said mobile communication device for the time required to download said file; and
apparatus that provides a display in the time domain indicating whether said present charge is sufficient to accommodate the downloading of said file.

5. The charge indicator of claim 2 further comprising:
apparatus for receiving information indicating the in-service life of said battery to defined a discharge curve for said battery; and
said apparatus uses said discharge curve in said determinations of said estimated service life of said present charge of said battery.

6. The charge indicator of claim 1 wherein said active mode of said communication device comprises a talk mode and a data mode;
said estimated service life of said charge for said active mode is calculated based upon the estimated service life of said charge for said idle mode multiplied by a percentage factor.

7. The charge indicator of claim 2 wherein the estimated service life of said charge for said active mode is based upon the signal strength transmitted by said mobile communication device during said active mode.

8. The charge indicator of claim 2 wherein the estimated service life of said charge for said active mode is determined by the reception of a control signal from the communication network serving said mobile communication device; and
said control signal specifies the transmitted signal power to be used by said mobile communication device during said active mode.

9. The charge indicator of claim 2 wherein the estimated service life of said charge for said active mode is determined by sampling the power usage of said mobile communication device during said active mode.

10. A method of determining an estimated service life of a charge of an energy source, such as a battery, adapted for use in a mobile communication device, said method comprising the steps of:
receiving an indication of the magnitude of the present charge of said battery;
receiving information defining at least one characteristic of said battery;
using said indication and said received information to determine an estimated service life of said present charge of said battery for an idle mode of said mobile communication device;
using said indication and said received information to determine an estimated service life of said present charge of said battery for an active mode of said mobile communication device; and
in response to said determinations, providing visual indications in a time domain of said estimated service life of said present charge of said battery for said idle mode and for said active mode of said mobile communication device.

11. The method of claim 10 further comprising the steps of:
receiving information defining at least one characteristic of said battery for use in said determinations of said estimated service life of said present charge of said battery.

12. The method of claim 11 wherein said received information specifies the type of said battery for use in said determinations of said estimated service life of said present charge of said battery.

13. The method of claim 11 wherein saidreceived information specifies the charge capacity of said battery for use in said determinations of said estimated service life of said present charge of said battery.

14. The method of claim 11 wherein saidreceived information indicates the cumulative in-service hours of said battery for use in said determinations of said estimated service life of said present charge of said battery.

15. The method of claim 11 wherein said estimated life of said charge for said idle mode is greater than the estimated service life of said charge for said active mode.

16. The method of claim 11 wherein saidreceived information defines the cumulative in-service time of said battery, said method includes the further steps of:
receiving said defined in-service life of said battery to define a discharge curve for said battery that compensates for the in-service time of said battery; and
using said defined discharge curve in said determination as of said estimated service life of said present charge of said battery.

17. The method of claim 12 comprising the further steps of:
providing a visual indication said estimated service life of said present charge of said battery in a time domain for each of said modes.

18. The method of claim 10 wherein the estimated service life of said charge magnitude for said active mode is based upon the signal strength transmitted by said mobile communication device during said active mode.

19. The method of claim 10 wherein the estimated service life of said charge magnitude for said active mode is determined by sampling of the power usage of said mobile communication device during said active mode.

20. The method of claim 10 comprising the further steps of:
receiving information indicating the size of a file to be downloaded;
determining the estimated service life of the present charge of said battery;
in response to said reception of information indicating said file size as well as said determination of said estimated service life of said present charge of said battery, determining whether said estimated service life of said present charge of said battery is sufficient to operate said mobile communication device for the time required to download said file; and
generating of a display indicating whether said present charge is sufficient to download said file.
